(19) United States
(12) Patent Application Publication
(10) Pub. No.: US 2020/0265307 A1
(43) Pub. Date: Aug. 20, 2020

(54) APPARATUS AND METHOD WITH MULTI-TASK NEURAL NETWORK

(71) Applicant: Samsung Electronics Co., Ltd., Suwon-si (KR)

(72) Inventor: SungJoo SUH, Seoul (KR)

(73) Assignee: Samsung Electronics Co., Ltd., Suwon-si (KR)

(21) Appl. No.: 16/691,762

(22) Filed: Nov. 22, 2019

(30) Foreign Application Priority Data
Feb. 18, 2019 (KR) 10-2019-0018400

(51) Int. Cl. G06N 3/08; G06N 3/04; G06F 16/22

(52) U.S. Cl. CPC G06N 3/08; G06F 16/2228; G06N 3/04

(57) ABSTRACT

Provided is a neural network method and apparatus. The method includes determining a target task with respect to input data, acquiring a second parameter that is prestored to correspond to the target task among first parameters included in a neural network for a plurality of tasks, adapting the neural network to the target task by setting a value of a portion of the first parameters of the neural network to a value of the second parameter, and implementing the adapted neural network with respect to the input data, and may include obtaining an importance matrix for neural network, determining one or more key parameters of the neural network, updating the importance matrix with respect to the determined one or more key parameters, and training the neural network with training data and for a new task using the updated importance matrix.

### CROSS-REFERENCE TO RELATED APPLICATIONS

This application claims the benefit under 35 USC § 119(a) of Korean Patent Application No. 10-2019-0018400 filed on Feb. 18, 2019 in the Korean Intellectual Property Office, the entire disclosure of which is incorporated herein by reference for all purposes.

### BACKGROUND

### 1. Field

The following description relates to apparatuses and methods with multi-task neural networks.

### 2. Description of Related Art

As a non-limiting example, in a case of performing sequential task learning in, or training of, a neural network, a neural network that has been trained for a current task may be retrained for a new task. However, the new resulting trained neural network may demonstrate a catastrophic forgetting issue of forgetting the previously learned or trained task, and thus, may only remember or be able to perform the new task.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a processor implemented neural network method includes determining a target task with respect to input data, acquiring a second parameter that is prestored to correspond to the target task among first parameters included in a neural network for a plurality of tasks, adapting the neural network to the target task by setting a value of a portion of the first parameters of the neural network to a value of the second parameter, and implementing the adapted neural network with respect to the input data for the target task.

The second parameter may include at least one of a parameter corresponding to a key neuron for the target task, an index of the key neuron, a parameter corresponding to a key synapse for the target task, and an index of the key synapse.

The second parameter may include at least one of a parameter corresponding to a key filter for the target task and an index of the key filter.

The method may further include receiving the input data, and the determining of the target task may include estimating the target task based on the input data.

The adapting of the neural network may include initializing the neural network to include all of the first parameters, and updating, to generate the adapted neural network, the initialized neural network based on the second parameter.

The target task may correspond to one of the plurality of tasks.

The method may further include obtaining an importance matrix with respect to the neural network for the plurality of tasks, determining one or more key parameters of the neural network for the plurality of tasks, updating the importance matrix with respect to the determined one or more key parameters, and training the neural network for the plurality of tasks with training data and for a new task using the updated importance matrix.

In one general aspect, there may be provided a non-transitory computer readable storage medium storing instructions that, when executed by a processor, cause the processor to one or more or all, or any combination thereof, of operations described herein.

In one general aspect, a processor implemented neural network method includes training a neural network based on first training data for a first task, the trained neural network including a plurality of parameters, extracting a second parameter from among the plurality of parameters based on determined importances of the plurality of parameters, storing a value of the second parameter, updating the importances, including updating an importance of the second parameter among the determined importances, and retraining the neural network based on the updated importances and second training data for a second task.

The updating of the importances may include updating the importance of the second parameter by setting an element value of an importance matrix corresponding to the second parameter to a first logic value.

The method may include determining the imporances of the plurality of parameters by calculating the importances of the plurality of parameters.

The calculating of the importances may include calculating the importances of the plurality of parameters based on a set importance matrix.

The second parameter may include at least one of a parameter corresponding to a key neuron for the target task among a plurality of neurons included in the neural network, an index of the key neuron, a parameter corresponding to a key synapse for the target task among a plurality of synapses included in the neural network, and an index of the key synapse.

In one general aspect, a neural network apparatus includes a processor configured to determine a target task with respect to input data, acquire a second parameter that is prestored in a memory to correspond to the target task among first parameters included in a neural network for a plurality of tasks, adapt the neural network to the target task by setting a value of a portion of the first parameters of the neural network to a value of the second parameter, and implement the adapted neural network with respect to the input data for the target task.

The apparatus may further include a communication interface configured to receive the input data and the memory.

The second parameter may include at least one of a parameter corresponding to a key neuron for the target task, an index of the key neuron, a parameter corresponding to a key synapse for the target task, and an index of the key synapse.

The second parameter may include at least one of a parameter corresponding to a key filter for the target task and an index of the key filter.

For the determination of the target task, the processor may be configured to estimate the target task based on the input data.

For the adapting of the neural network, the processor may be configured to initialize the neural network to include all of the first parameters, and update the initialized neural network based on the second parameter.

The target task may corresponds to one of the plurality of tasks.

In one general aspect, a neural network apparatus includes a processor configured to train a neural network based on first training data for a first task, with the first trained neural network including a plurality of parameters, extract a second parameter from among the plurality of parameters based on determined importances of the plurality of parameters, store a value of the second parameter, update the importances, including an update of an importance of the second parameter among the determined importances, and retrain the neural network based on the updated importances and second training data for a second task, and a memory configured to store the value of the second parameter.

The processor may be configured to update the importance of the second parameter by setting an element value of an importance matrix corresponding to the second parameter to a first logic value.

The processor may be configured to determine the importances of the plurality of parameters by calculating the importances of the plurality of parameters.

The processor may be configured to calculate the importances of the plurality of parameters based on a set importance matrix.

The second parameter may include at least one of a parameter corresponding to a key neuron for the target task among a plurality of neurons included in the neural network, an index of the key neuron, a parameter corresponding to a key synapse for the target task among a plurality of synapses included in the neural network, and an index of the key synapse.

In one general aspect, a processor implemented neural network method includes obtaining first parameters of a neural network trained for a plurality of tasks, wherein the obtained first parameters of the neural network are configured to implement less than the plurality of tasks, acquiring one or more second parameters prestored to correspond to a target task among the plurality of tasks, adapting the neural network trained for the plurality of tasks to include all of the first parameters except for one or more parameters of the first parameters that are respectively replaced by the one or more second parameters, and implementing the adapted neural network with respect to input data for the target task.

The method may further include obtaining an importance matrix with respect to the neural network trained for the plurality of tasks, determining one or more key parameters of the neural network trained for the plurality of tasks, updating the importance matrix with respect to the determined one or more key parameters, and training the neural network trained for the plurality of tasks with training data and for a new task using the updated importance matrix.

The updating of the importance matrix may include updating an importance value corresponding to each of the one or more determined key parameters to a first logic value.

The method may further include generating the importance matrix by calculating importances of respective parameters of the neural network trained for the plurality of tasks.

The one or more second parameters may include at least one of a parameter corresponding to a key neuron for the target task, an index of the key neuron, a parameter corresponding to a key synapse for the target task, and an index of the key synapse.

The one or more second parameters may include at least one of parameter corresponding to a key filter for the target task and an index of the key filter.

In one general aspect, a processor implemented neural network method includes obtaining first parameters of a trained neural network trained for a first task, obtaining an importance matrix with respect to the neural network, obtaining one or more key parameters of the neural network, updating the importance matrix with respect to the determined one or more key parameters, and retraining, using a loss dependent on the updated importance matrix, the neural network with training data to have a plurality of parameters configured to implement a second task.

The method may further include acquiring one or more second parameters prestored to correspond to a target task, adapting the retrained neural network to include all of the plurality of parameters except for one or more parameters of the plurality of parameters that are respectively replaced by the one or more second parameters, and implementing the adapted neural network with respect to input data for the target task.

The updating of the importance matrix may include updating an importance value corresponding to each of the one or more key parameters to a first logic value.

The method may further include generating the importance matrix by calculating importances of respective parameters of the neural network trained for the first task.

The one or more key parameters may include at least one of a parameter corresponding to a key neuron for the target task, an index of the key neuron, a parameter corresponding to a key synapse for the target task, and an index of the key synapse.

The one or more key parameters may include at least one of parameter corresponding to a key filter for the target task and an index of the key filter.

Other features and aspects will be apparent from the following detailed description, the drawings, and the claims.

### BRIEF DESCRIPTION OF THE DRAWINGS

FIG. 1 is a flowchart illustrating an example of a method of implementing a target task using a neural network.

FIG. 2 illustrates an example of a method of implementing a target task using a neural network.

FIG. 3 is a flowchart illustrating an example of a method of training a neural network for multiple tasks.

FIG. 4 illustrates an example of a method of training a neural network for multiple tasks.

FIGS. 5A and 5B illustrate examples of a process of calculating respective importances of a plurality of parameters included in a neural network.

FIGS. 6A and 6B respectively illustrate examples of a process of storing one or more parameter information that have been determined important for each of plural tasks and a process of extracting from the stored parameters the previously determined important parameter information for a corresponding particular task and implementing the corresponding neural network based on the extracted parameter information.

FIG. 7 is a diagram illustrating an example of a neural network apparatus configured to implement training and/or inference neural network operations, e.g., among other operations of the neural network apparatus.

Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known in the art may be omitted for increased clarity and conciseness.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Throughout the specification, when an element, such as a layer, region, or substrate, is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Unless otherwise defined, all terms, including technical and scientific terms, used herein have the same meaning as commonly understood by one of ordinary skill in the art to which this disclosure pertains after an understanding of the disclosure of this application. Terms, such as those defined in commonly used dictionaries, are to be interpreted as having a meaning that is consistent with their meaning in the context of the relevant art and the disclosure of the present application, and are not to be interpreted in an idealized or overly formal sense unless expressly so defined herein.

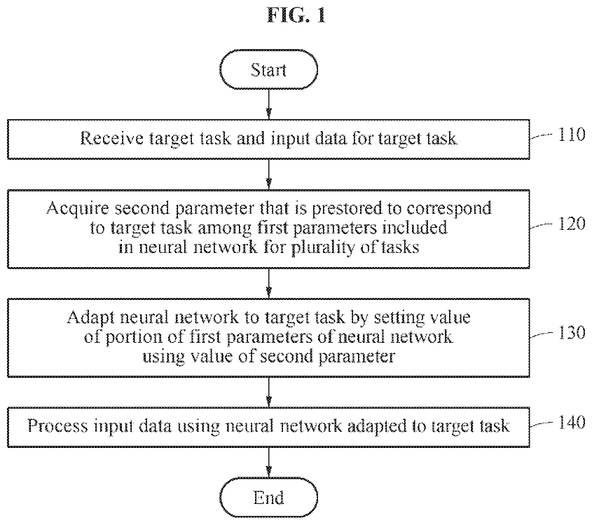

FIG. 1 is a flowchart illustrating an example of a method of implementing a target task using a neural network. Referring to FIG. 1, in operation 110, a neural network apparatus, also referable to as a data processing apparatus, receives information indicating a target task and input data for the target task. The target task may correspond to a task that is to be performed by the neural network apparatus using a learned neural network. For example, learned neural network may be considered a multi-task trained neural network (also referred to as a neural network for a plurality of tasks), where the target task may be one of a plurality of tasks the neural network had been trained to implement at different discontinuous times and/or sequentially in time, as a non-limiting example. The plurality of tasks that the neural network may be trained with respect to may have a predetermined similarity and/or commonness therebetween, such as for example, a type of input data input to the neural network during each of the trainings of the neural network to generate respectively trained neural networks for the tasks, a type of output data output from the neural network as respective trained objectives of the respectively trained neural networks, a type of a service provided through the neural network with respect to each of the tasks, and a domain adapted by the neural network with respect to each of the tasks. The plurality of tasks may include, for example, voice recognition, image recognition, and search. However, it is provided as an example only. The plurality of tasks may include any type of tasks that may be performed by an apparatus and/or a robot, for example, through implementation of the neural network with respect to parameters information for the particular task to be implemented. Here, the use of the term “may” with respect to an example or embodiment, e.g., as to what an example or embodiment may include or implement, means that at least one example or embodiment exists where such a feature is included or implemented while all examples and embodiments are not limited thereto.

The neural network apparatus may directly receive information or instruction of the input target task, or may estimate the target task from input data. For example, if the input data is a video of a coin laundromat, the neural network apparatus may perform a task estimation process that estimates the target task from the video of the coin laundromat. In this example, the neural network apparatus may recognize a corresponding place as a coin laundromat through a surrounding environment that is verified by the neural network apparatus from the input data. The neural network apparatus may then estimate the target task, for example, to be washing clothes, determined suitable for the recognized place, and initiate performance of the task using a selective adaptation, as explained further below, of the trained neural network. The trained neural network, as well as the adaptation (e.g., parameter) information for one or more tasks, may be stored in a memory of the neural network apparatus.

In operation 120, the neural network apparatus acquires one or more second parameters that are prestored to correspond to the target task with respect to corresponding first parameters of the trained neural network for the plurality of tasks. The neural network for the plurality of tasks may be, as non-limiting examples, a deep neural network (DNN), a convolutional neural network (CNN), or a recurrent neural network (RNN). In an example, the neural network for the plurality of tasks may be a single neural network that includes a plurality of neurons and a plurality of synapses in multiple layers. In an example, the neural network for the plurality of tasks may be representative of a single layer or select collection of layers of a multi-layer neural network.

Thus, the first parameters may refer to parameters that are resultant of the neural network having been sequentially trained with respect to each of the plurality of tasks, e.g., including the target task. The second parameter may include or be representative of, for example, one or more of parameters corresponding to key one or more neurons for the target task, indices of the one or more key neurons, one or more parameters corresponding to key one or more synapses for the target task, and indices of the one or more key synapses, as non-limiting examples.

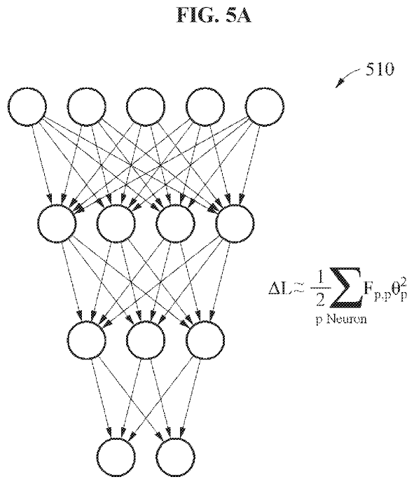

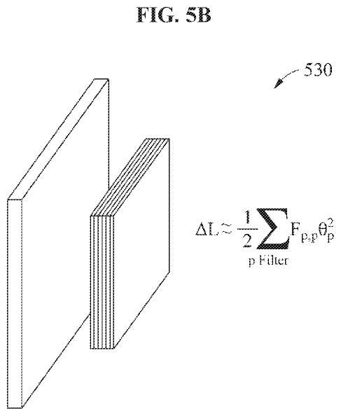

The terms ‘key neuron’ and/or ‘key synapse’ may correspond to one or more neurons and/or one or more synapses of which a determined respective importance, e.g., calculated based on corresponding importance matrix, meets or has met a corresponding importance threshold for the corresponding task implementation of a corresponding neural network with the key neuron(s)/synapse(s). For example, some neurons and/or synapses may have a determined greater impact or effect, compared to other neurons and/or synapses, on output and/or accuracy of a corresponding neural network, as trained to perform a particular task. A meeting of the example importance threshold may be reflected by a determination that an importance, for a neuron or synapse, calculated based on the example importance matrix of the corresponding neural network has a value greater than a predetermined reference among all other calculated importances the plurality of neurons and/or the plurality of synapses included in the same neural network. In an example, the importance matrix may represent importances of parameters included in the neural network through sequential learning of the neural network. The importance matrix may be, for example, a fisher information matrix. Here, while below references may be made to a single important neuron, a key neuron, or a corresponding second parameter of such a single key or important neuron, such references should be understood to mean that there may be one as well as a plurality of respective important neurons, key neurons, or second parameters for a plurality of such key or important neurons, and while references may be made to a single important synapse, key synapse, or a corresponding second parameter of such a single key synapse or important synapse, such references should be understood to mean that there may be one as well as a plurality of respective important synapses, key synapses, or corresponding second parameters for a plurality of such key synapses or important synapses. Also, references to a key or important neuron and/or a key or important synapse, has a meaning consistent with an example existing with only key or important neuron(s) being, or having been, determined and stored, an example existing where with only key or important synapse(s) being, or having been, determined and stored, and an example existing where a combination of key or important neuron(s) and key or important synapse(s) are determined, or have been determined, and are stored. In an example, a synapse may also be referred as a weighted connection, e.g., as weighted connection between neurons. Thus, here, a parameter corresponding to a key neuron and/or a parameter corresponding to a key synapse may be, for example, a weight value or a bias value corresponding to the key neuron and/or the key synapse. As another example, referring to FIG. 5B, in an example where the neural network is a CNN, the second parameter may include at least one of a parameter corresponding to a key filter (or kernel) for the target task among a plurality of filters included in the CNN and an index of the key filter. Here, the second parameter may also be referred to as a key parameter.

Accordingly, in an example, information on the second (or key) parameter may be stored in the memory of the neural network apparatus to correspond to the target task. Information on the second parameter may include, for example, location information of the second parameter(s) and value(s) of the second parameter(s).

In operation 130, the neural network apparatus adapts the neural network for the plurality of tasks, e.g., according to the first parameters, to be a neural network for the target task by setting respective values of a portion of the first parameters of the neural network for the plurality of tasks to a values of the second parameters. For example, the neural network apparatus may initialize the neural network based on the first parameters that are applied to the plurality of tasks. Also, the neural network apparatus may adapt the initialized neural network based on stored second parameters corresponding to the target task, and implement the adapted neural network to perform the target task.

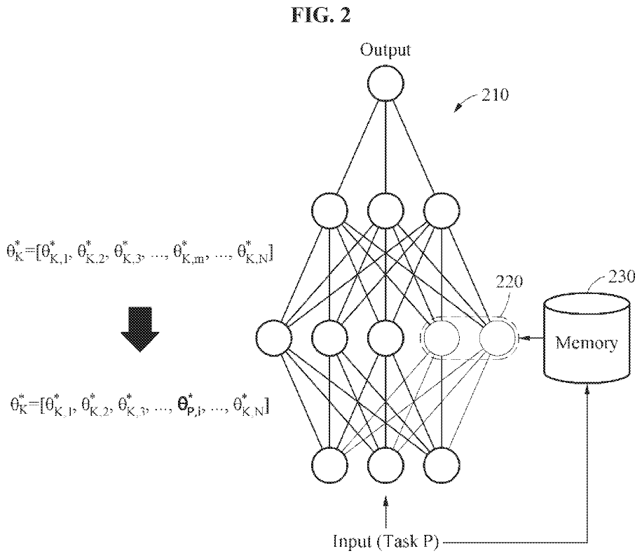

In a case of performing a task, e.g., a target task among tasks learned using the neural network, the neural network apparatus may adapt or update a portion of parameters, for example, first parameters, included in the neural network using the second parameter, which may provide a stable processing performance even with respect to the target task and/or a task aside from the target task, for example. In an example, the neural network apparatus may implement continuous learning, where the neural network may be re-trained for a new task when selected by a user or determined by the neural network apparatus, in which case new first parameters of the new task trained neural network may be trained, and the newly trained neural network may perform the new task by implementing the new first parameters, while still also being adaptable for previous trained tasks through respectively stored second parameters of each of the previous trained tasks, for example. Thus, the neural network apparatus may be employed in various application fields based on a single neural network, for example, that performs continuous learning. A process of adapting, by the neural network apparatus, the neural network of first parameters to the target task using the second parameter is further described with reference to FIG. 2.

In operation 140, the neural network apparatus processes the input data using the neural network adapted to the target task.

FIG. 2 illustrates an example of a method of implementing a target task using a neural network. Referring to FIG. 2, in a neural network 210 that includes a plurality of neurons and a plurality of synapses, after learning of a K^{th} task is completed, a previously learned P^{th} task may be indicated, e.g., based on an input or input data to the neural network apparatus, to be a target task for the input data, for example.

For example, learning of the K^{th} task may have been completed with respect to the neural network 210, through learning of various tasks, such as a learning of task A, a learning of task B, a learning of the task P, and a latest learning of the K^{th} task. Here, the task A may be a task of classifying foods, the task B may be a task of classifying persons, and the task P may be a task of classifying vehicle brands, for example.

When learning of the K^{th} task has been completed, the resultant trained parameters of the neural network 210 may be represented as

θ*_{K}=[θ*_{K,1}, θ*_{K,2}, θ*_{K,3}, . . . , θ*_{K,m}, . . . , θ*_{K,N}]

While the neural network with these trained parameters are trained to accomplish the K^{th} task, for example, in response to a photo of vehicle XX being received as input data and the task P being determined or indicated as the target task, the neural network apparatus may acquire, from the memory 230, information on parameters, for example, key parameters 220, prestored as corresponding to the task P. Here, as noted previously, values of the key parameters 220 corresponding to a key neuron and/or a key synapse for each task and location information of the key parameters 220 in the neural network 210 may be stored in the memory 230, where the location information may indicate which neuron or node or which synapse of the first parameters of the neural network 210 respectively correspond to the stored key parameters 220. Herein, one or more key parameters 220 may be present. In addition, the memory may store one or more key parameters 220 for each of a plurality of tasks, and each of these one or more key parameters may be referred to as a task parameter set. Accordingly, the memory 230 may store a plurality of task parameter sets respectively corresponding to the plurality of tasks. The neural network apparatus may determine a portion, that is, a parameter value of a neuron or a synapse, to be updated in the neural network 210 from the acquired information on the parameters stored in the memory 230 as corresponding to the task P.

The neural network apparatus thus loads the information on the key parameter 220 that is stored in the memory 230 to correspond to the task P to be performed. The information may be, for example, a value of the key parameter 220 corresponding to the target task and a location of the key parameter 220 with respect to the corresponding first parameter in the neural network 210 trained with respect to the K^{th} task. The neural network apparatus may adapt the neural network 210 to the target task by updating a value of a portion of the parameters of the neural network 210 with the value of the key parameter 220 corresponding to the task P loaded from the memory 230.

Accordingly, adapted parameters included in the adapted neural network 210, i.e., adapted to the task P may now be represented as θ*_{K}=[θ*_{K,1}, θ*_{K,2}, θ*_{K,3}, . . . , θ*_{P,i}, . . . , θ*_{K,n}]

In one example, the neural network apparatus may reconstruct or adapt the neural network 210 so to excellently, e.g., within predetermined excellence or accuracy threshold(s), operate for a different (and previously trained) task, i.e., even when the neural network 210 has been previously been trained for multiple tasks, by using the previously determined key or important parameters 220 corresponding to the key neuron and the key synapse stored in the memory 230 with respect to previous training of the neural network with respect to the P^{th} task. The neural network apparatus may then implement the adapted neural network 210, with all of the first parameters less those replaced or modified/adapted with or according to the parameters 220. Accordingly, it is possible to maintain a relatively high processing performance with respect to a previously learned task, to implement the previously learned task, after further training of the neural network for another task.

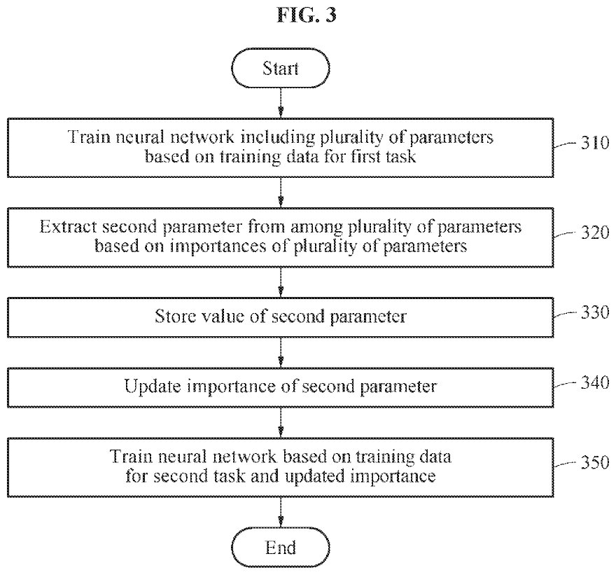

FIG. 3 is a flowchart illustrating an example of a method of training a neural network for multiple tasks. Referring to FIG. 3, in operation 310, a neural network apparatus trains a neural network through iterative adjusting of a plurality of parameters based on training data for a first task. For example, the training of the neural network for the first task may be performed until the neural network performs the first task within predetermined sufficient accuracy and/or minimum error thresholds, the parameters of the neural network at that time may also be referred to as trained parameters of the trained neural network.

In operation 320, the neural network apparatus extracts a second parameter from among the plurality of parameters based on determined importances of the plurality of parameters. For example, the neural network apparatus may calculate importances of the plurality of parameters based on a preset (or, alternatively, determined) importance matrix, for example. The neural network apparatus may extract the second parameter from among the plurality of parameters based on the determined importances of the plurality of parameters. For example, the neural network apparatus may calculate the importances of the plurality of parameters based on a summing of element values of the importance matrix, such as based on the importance matrix being a fisher importance matrix. Here, though references to an importance matrix, or the further example of the fisher importance matrix are discussed, examples are not limited thereto.

In operation 330, the neural network apparatus stores a value of the second parameter. Here, the second parameter may include, for example, one or more or any combination of a parameter corresponding to a key neuron for the trained-for first task among a plurality of neurons included in the neural network, an index of the key neuron, a parameter corresponding to a key synapse for the trained-for first task among a plurality of synapses included in the neural network, and an index of the key synapse.

In operation 340, the neural network apparatus updates an importance of the second parameter with respect to the importance matrix. For example, the neural network apparatus may update the importance of the second parameter by setting an element value, of the importance matrix, corresponding to the second parameter to a first logic value, for example, zero. Alternatively, the neural network apparatus may set this element value corresponding to the second parameter to a minimum element value of the importance matrix or other various real number values.

In operation 350, the neural network apparatus trains (retrains) the neural network based on training data for a second task and with respect to the updated importance, e.g., the trained parameters of the trained neural network resulting from the previous training with respect to the first task may be newly iteratively adjusted until the newly trained neural network performs the second task within predetermined sufficient accuracy and/or minimum error thresholds. For example, the neural network apparatus may perform this training of the neural network with respect to the second task based on a loss function that is configured such that a change in the value of the second parameter may decrease as the corresponding element value of the importance matrix corresponding to the second parameter increases with respect to a preset (or, alternatively, determined) reference value.

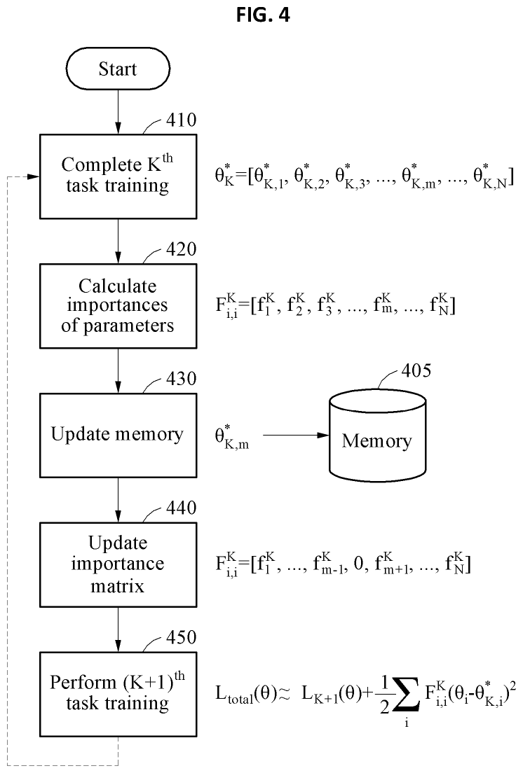

FIG. 4 illustrates an example of a method of training a neural network for multiple tasks. Hereinafter, a process of updating parameters of a neural network in a memory 405 is described with reference to FIG. 4.

Referring to FIG. 4, once a K^{th} training task is completed in operation 410, a neural network apparatus calculates or measures an importance of each of a neuron and/or synapse, that is, each parameter of a neural network in operation 420.

For example, when the K^{th} training task is completed, parameters of the neural network may be represented as θ*_{K}=[θ*_{K,1}, θ*_{K,2}, θ*_{K,3}, . . . , θ*_{K,m}, . . . , θ*_{K,N}].

In operation 420, the neural network apparatus calculates or measures importances of the parameters of the neural network through an importance matrix, for example, a fisher information matrix. Here, the fisher information matrix may be a matrix that represents an amount of information inferable for an unknown parameter of a distribution of probability variables from an observable value of a random probability variable. For example, the fisher information matrix may be calculated or measured as F_{i,i}^{K}=[f₁^{K}, f₂^{K}, f₃^{K}, . . . , fₘ^{K}, . . . , f_{N}^{K}]. The neural network apparatus calculates or measures the importance of a corresponding parameter so as to be a relatively higher value the greater an amount of information by the fisher information matrix increases to be greater than a preset (or, alternatively, determined) reference value. In an example, the neural network apparatus may calculate or measure the importance of a corresponding parameter so as to be a relatively lower value as an amount of information by the fisher information matrix decreases to be less than the reference value.

For example, all of parameters included in a portion (or all) of a neural network A may be represented as a 1-dimensional (1D) vector. For example, the parameters of the neural network A may be represented using a vector, such as W=[w₁₁, w₁₂, . . . , w₂₁, w₂₂, . . . , w_{NM}], such as where w₁₁ may represent a trained weighted connection from a first neuron (or ‘node’) of a first layer to a first neuron of a next layer of the neural network, w₁₂ may represent a trained weighted connection from the first neuron of the first layer to a second neuron of the next layer, . . . , w₂₁ may represent a trained weighted connection from a second neuron of the first layer to the first neuron of the next layer, w₂₂ may represent a trained weighted connection from the second neuron of the first layer to second first neuron of the next layer, . . . , and w_{NM} may represent a trained weighted connection from the N^{th} neuron of the first layer to M^{th} neuron of the next layer. In this example, there may be N neurons in the first layer and M neurons in the second layer. For this non-limiting example, the fisher information matrix may be acquired as, for example, a diagonal matrix with a size of NM×NM. Here, an importance corresponding to each of the parameters in the neural network A, e.g., with respect to the edge or weighted connections between the first and second layers, may correspond to the fisher information matrix. Accordingly, the neural network apparatus may calculate an importance for each parameter through a sum of values of the fisher information matrix corresponding to the respective parameters, for example, Σₚ F_{p,p}. Here, the importance for each parameter may be understood to include an importance for each neuron and/or importance for each synapse of the neural network or each neuron and/or importance of multiple layers, even though the above example demonstrates the example of determining the importance of weighted connections between the example two layers of the neural network A.

An example of a method of calculating, by the neural network apparatus, an importance of each parameter of a neural network is described with reference to FIGS. 5A-5B.

Referring again to FIG. 4, in operation 430, the neural network apparatus extracts a key parameter from among the parameters based on the importances of the parameters calculated in operation 420, and stores the extracted key parameter in the memory 405. For example, the neural network apparatus may store, in the memory 405, values of multiple key parameters among the parameters calculated in operation 420, such as a total number of key parameters corresponding to a predetermined number of parameters among the parameters calculated in operation 420. For example, when an importance of a parameter θ*_{K,m} is determined to have a highest value among the calculated importances of the remaining parameters of the neural network in correspondence to the K^{th} task, the neural network apparatus may determine the θ*_{K,m} as being a key parameter corresponding to the K^{th} task. For example, the neural network apparatus may store, in the memory 405, a value of the key parameter θ*_{K,m} and location information of the key parameter θ*_{K,m}, for example, an index of a neuron and/or an index of a synapse corresponding to the key parameter θ*_{K,m}, in correspondence to the K^{th} task. In the example where a predetermined total number of key parameters are stored for each task, those parameters whose highest values of calculated importances up to the predetermined total number of key parameters may be stored as key parameters for the K^{th} task. While the example of a predetermined number of key parameters being stored in memory for any given task is mentioned, examples are not limited there to.

Alternatively or additionally, when a particular neuron, e.g., a second neuron, of the neural network is determined as a key neuron corresponding to the K^{th} task, the neural network apparatus may store, in the memory 405, a vector having element values, such as w₂₁, w₂₂, . . . , w_{2M} corresponding to the example second neuron of the neural network with location information. In this example, the vector may represent all synapses or weighted connections from the example second neuron to a next layer, for example.

In operation 440, the neural network apparatus updates an importance value corresponding to the example key parameter θ*_{K,m} in the importance matrix F_{i,i}^{K}=[f₁^{K}, f₂^{K}, f₃^{K}, . . . , fₘ^{K}, . . . , f_{N}^{K}].

For example, the neural network apparatus may update the importance matrix corresponding to the K^{th} task by setting an element value of the importance matrix F_{i,i}^{K}=[f₁^{K}, f₂^{K}, f₃^{K}, . . . , fₘ^{K}, . . . f_{N}^{K}] corresponding to the key parameter θ*_{K,m} to zero, to thereby generate the updated importance matrix F_{i,i}^{K}=[f₁^{K}, . . . , f₁^{K}, . . . , fₘ₋₁^{K}, 0, fₘ₊₁^{K}, . . . , f_{N}^{K}]. In one example, the neural network apparatus may set the element value of the importance matrix to not zero but a minimum element value of the importance matrix, for example.

In operation 450, the neural network apparatus performs a (K+1)^{th} training task based on the updated importance matrix.

For example, the neural network apparatus may enhance a training ability of a neural network for the (K+1)^{th} task by updating an element value of the importance matrix corresponding to the (K+1)^{th} task as discussed above and retraining the trained parameters of the neural network trained for the K^{th} task to generate the neural network trained for the (K+1)^{th} task. For example, with such an approach, the neural network apparatus may attenuate or prevent a size of a corresponding neural network from being infinitely enlarged as the neural network is repeatedly re-trained for multiple tasks, such as by the setting of the element value of the importance matrix corresponding to the determined key or important parameters for the K^{th} task to zero, and may thereby generate a multi-task neural network having been trained with respect to the K^{th} task and most recently trained with respect to the new task, the (K+1)^{th} task.

For example, the importance matrix having been updated with respect to the key parameters of the K^{th} task may be used to derive a loss function (Lₜₒₜₐₗ(θ)) for learning the (K+1)^{th} task as represented by the following Equation 1, for example.

$${L}_{total} ( θ ) \approx {L}_{K + 1} ( θ ) + \frac{1}{2} {\sum }_{i} {{F}_{i , i}^{K} ( {θ}_{i} - {θ}_{K , i}^{*} )}^{2} \qquad Equation 1$$

In Equation 1, θ denotes the entire trained parameters, for example, first parameters of the neural network trained to perform a task, K denotes an index of the task, and F_{i,i}^{K} denotes the updated importance matrix with respect to the K^{th} task. Here, (i,i) denote diagonal elements in F_{i,i}^{K}. Also, θᵢ denotes a value of an i^{th} parameter in the (K+1)^{th} task and θ*_{K,i} denotes a value of an i^{th} parameter in the K^{th} task.

For example, an iterative adjustment of values of parameters may be updated such that cost calculated using a loss function in the case of performing training may decrease. A parameter with a relatively high importance may further affect the loss function. In the case of a parameter with a relatively high importance, cost calculated using the loss function may decrease when a difference between θᵢ and θ*_{K,i} is small. Accordingly, in the case of the parameter with the relatively high importance, training may proceed to maintain a value of a previous task. In one example, a value of a parameter with a relatively high importance in the previous task may be separately stored and may be set to be relatively low compared to those of other parameters.

FIGS. 5A and 5B illustrate examples of a process of calculating respective importances of a plurality of parameters included in a neural network. FIG. 5A illustrates an example of a DNN 510 and FIG. 5B illustrates an example of a CNN 530.

In one example, a neural network apparatus may calculate an importance for an individual neuron and/or an individual synapse included in the neural network. For example, the neural network apparatus may remove a connection of a single synapse or a single neuron included in the neural network and may calculate an importance for remaining synapses excluding the removed synapse or remaining neurons excluding the removed neuron, as represented by the following Equation 2, for example.

$${L}_{A , B} ( θ ) \approx {L}_{B} ( θ ) + \frac{1}{2} {\sum }_{i} {{F}_{i , i}^{A} ( {θ}_{i} - {θ}_{A , i}^{*} )}^{2} \\ {L}_{A , {A}^{′}} ( θ ) \approx {L}_{{A}^{′}} ( θ ) + \frac{1}{2} {\sum }_{i} {{F}_{i , i}^{A} ( {θ}_{{A}^{′} , i} - {θ}_{A , i}^{*} )}^{2} \\ Δ L \approx \frac{1}{2} {F}_{p , p} {θ}_{p}^{2} \qquad Equation 2$$

In Equation 2, L_{A,B}(θ) denotes a loss function for learning a new task B in a state in which a task A is pre-learned. Here, L_{A,B}(θ) includes a first turn about the loss function L_{A,B}(θ) of the new task B and a second term about a difference based on an importance of a parameter pre-learned in the task A. Here, F_{i,i}^{A} denotes an importance in the task A and θ*_{A,i} denotes a value of the i^{th} parameter of the neural network that is determined in response to training the task A. Here, θᵢ denotes the i^{th} parameter that is being currently learned.

L_{A,A′}(θ) denotes a loss function for learning a task A′ in which a specific parameter p, for example, a specific synapse, is removed. Here, θ_{A′,i} denotes a value of the i^{th} parameter of the neural network in the case of a current iteration of the task A′. Further, L_{A,A′}(θ) may be derived by substituting a term about the task B in L_{A,B′}(θ) with a term about the task A′.

ΔL denotes a variation of loss before and after removing the specific parameter p from the task A. Here, F_{p,p} denotes an importance of the specific parameter p in the task A and θₚ denotes the specific parameter P of the task A.

As described above, the neural network apparatus may calculate importances of the plurality of parameters included in the neural network by removing a connection of each individual neuron or each individual synapse included in the neural network one by one. For example, an importance of each parameter, for example, each synapse, may be calculated using ΔL.

Various examples methods of calculating importances of parameters of the neural network are available, and such methods may be different depending on a type of the corresponding neural network. For example, referring to FIG. 5A, in an example where the neural network is configured as the DNN 510, importances of a plurality of parameters included in the DNN 510 may be calculated according to Equation 2.

In an example, referring to FIG. 5B, where the neural network is configured as the CNN 530, importances of a plurality of parameters included in the CNN 530 may be calculated according to the following Equation 3, for example.

$$Δ L \approx \frac{1}{2} {\sum }_{p ∈ Filter} {F}_{p , p} {θ}_{p}^{2} \qquad Equation 3$$

Such different important determinations are due to structural differences between the DNN 510 and the CNN 530.

While the DNN 510 includes a plurality of neurons and a plurality of synapses, the CNN 530 includes a plurality of filters or kernels. Accordingly, a key parameter in the CNN 530 may include a parameter corresponding to a key filter for a target task among the plurality of filters included in the neural network and an index of the key filter, for example.

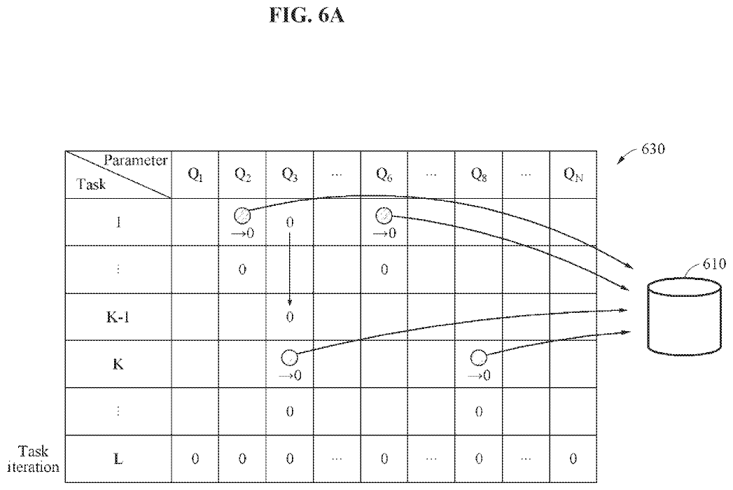

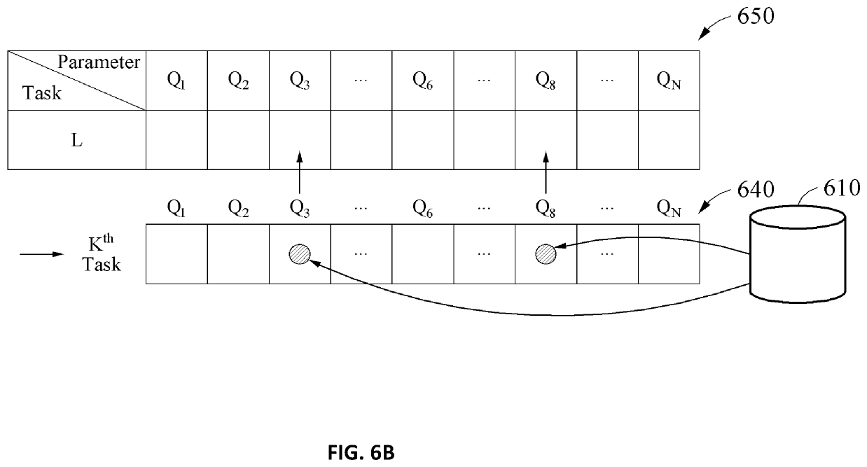

FIGS. 6A and 6B respectively illustrate examples of a process of storing one or more parameter information that have been determined important for each of plural tasks and a process of extracting from the stored parameters the previously determined important parameter information for a corresponding particular task and implementing the corresponding neural network based on the extracted parameter information. A method of storing, by the neural network apparatus, a a key parameter in a memory 610 is described with reference to FIG. 6A. As described above, the key parameter may be a parameter corresponding to a key neuron for a target task and/or may be a parameter corresponding to a key synapse for the target task.

In an example, upon the learning of a first task having been completed in a neural network that includes a total of N parameters (Q₁, Q₂, Q₃, . . . , Q_{N}), a second parameter Q₂ and a sixth parameter Q₆ among the N parameters (Q₁, Q₂, Q₃, . . . , Q_{N}) may be determined as key parameters corresponding to the first task and organized in memory, e.g., organized as table 630 illustrated in FIG. 6A.

For example, the neural network apparatus may store values of the key parameters, for example, the second parameter Q₂ and the sixth parameter Q₆, in the memory 610. In addition to values of the key parameters, the neural network apparatus may also store, in the memory 610, location information of the key parameters in the neural network, for example, an index of a key neuron and an index of a key synapse among respective indices set for all neurons or all synapses of a layer, multiple layers, or the entire neural network. For example, where indexed locations and neurons and/or synapses of the neural network are maintained regardless of a subsequent training of the neural network for a new task, the stored key neuron or synapse for the first task will still have identifiable correspondence with a particular neuron or synapse in the subsequently trained neural network through such set indices, such that when the stored key neuron or synapse for the first task replaces that particular neuron or synapse according to the stored index, the resulting adapted neural network may be capable of implementing the first task with predetermined excellence.

In this example, while key parameters of the neural network trained with respect to the first task are stored in memory 610, the neural network trained with respect to the first task may be implemented using all parameters (e.g., neurons and synapses) of the neural network trained with respect to the first task.

In addition, upon completion of the training of the neural network with respect to the first task, or upon a subsequent determination to train the neural network for a new task, the neural network apparatus may update an importance matrix corresponding to the first task by setting element values of the importance matrix corresponding to the key parameters, for example, corresponding to the second parameter Q₂ and the sixth parameter Q₆ to zeros as shown in the table 630. Thus, when or if the neural network apparatus performs training (e.g., retraining) of the neural network for the next task, e.g., a second task, the neural network apparatus may have available, or generate, for use the updated importance matrix, e.g., using the updated importance matrix in calculating losses considered in the training for the iterative adjustments of the respective parameters of the neural network until trained, e.g., to a predetermined accuracy threshold, for the second task. When the training of the neural network with respect to the second task is complete, important or key parameters may be determined, and stored.

Thereafter, the training apparatus may store, in the memory 610, values of key parameters, for example, a third parameter Q₃ and an eighth parameter Q₈, determined to correspond to the K^{th} task.

Accordingly, when learning is completed up to an L^{th} task, and values and location information for each of the intermediate tasks have been stored in the memory 610, values and location information of key parameters corresponding to the L^{th} task may be stored in the memory 610. Thus, the above processes may repeat when multiple tasks are trained at a particular time, but through sequential iteration, and/or some or all of the tasks may be trained at intermittent times that such new task learning is determined appropriate or instructed by a user and the multi-task neural network and already stored key parameters may be used to implement any of the tasks corresponding to the stored key parameters in the interim.

Thus, the neural network apparatus may store key parameters corresponding to each task in a single memory 610 as shown in FIG. 6A. In one example, the neural network apparatus may store key parameters in a separate memory for each task.

A process of extracting, by the neural network apparatus, a key parameter from the memory 610 is described with reference to FIG. 6B. For example, the discussion with respect to FIG. 6B will be with respect to learning having been performed up to the L^{th} task in the neural network and a target task to be currently performed is a previously learned K^{th} task with respect to the neural network.

In this example, the neural network apparatus may extract, from the memory 610, information stored to correspond to the K^{th} task. For example, as illustrated in FIG. 6B, the neural network apparatus may acquire values of stored key parameters, for example, the third parameter Q₃ (e.g., Q^{K}₃) and the eighth parameter Q₈ (e.g., Q^{K}₈), stored in the memory 610 corresponding to the K^{th} task.

As further illustrated in FIG. 6B, the neural network apparatus may update values of the third parameter Q₃ (e.g., Q^{L}₃) and the eighth parameter Q₈ (e.g., Q^{L}₈) of the neural network trained with respect to the L^{th} task with values of the example third parameter Q^{K}₃ and the example eighth parameter Q^{K}₈ stored in the memory 610. For example, the key parameters corresponding to the K^{th} task being loaded into memory or memory location 640, and then select parameters Q^{L}₃ and Q^{L}₈ of the neural network corresponding to the L^{th} task being adapted or replaced with key parameters Q^{K}₃ and Q^{K}₈ from memory or memory location 640 in memory or memory location 650 that currently stores all trained parameters of the neural network with respect to the L^{th} task. Thus, once the memory or memory location 650 is updated, all parameters stored in memory or memory location 650 may be used in the implementing of the adjusted/updated neural network to implement the K^{th} task.

If a new task is desired to be learned, then the un-updated memory or memory location 650 may be used, e.g., all trained parameters with respect to the training of the neural network with respect to the L^{th} task, after the importance matrix is updated with respect to determined key parameters corresponding to the L^{th} task, the neural network may be trained for the new task using the updated importance matrix, i.e., the importance matrix updated with respect to the L^{th} task.

Thus, in an example, performance of the neural network for a specific task may be maintained to be stable by updating a parameter of the neural network using a value of a key parameter stored in the memory 610 to correspond to the specific task, even after the neural network has been further trained to perform a different task. Accordingly, an example neural network apparatus may overcome a catastrophic forgetting issue of forgetting previously learned knowledge and remembering only most recent knowledge of typical sequentially trained neural networks.

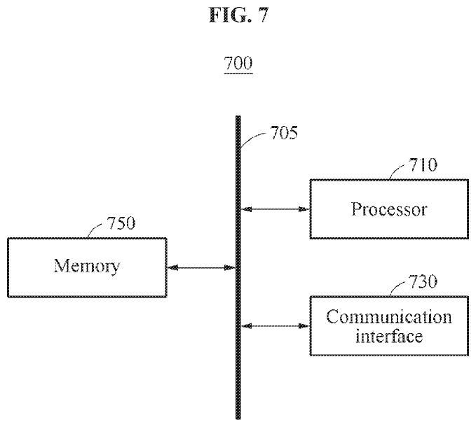

FIG. 7 illustrates an example of a neural network apparatus configured to implement training and/or inference neural network operations, e.g., among other operations of the neural network apparatus. Referring to FIG. 7, a neural network apparatus 700 includes a processor 710, a communication interface 730, and a memory 750. The processor 710, the communication interface 730, and the memory 750 may communicate with one another through a communication bus 705.

The processor 710 acquires a second parameter that is prestored in the memory 750. The processor 710 adapts a neural network to a target task by setting a value of a portion of first parameters included in the neural network to a value of a second parameter. The processor 710 processes input data using the neural network that is adapted to the target task.

The communication interface 730 receives the target task and input data for the target task.

The memory 750 stores a second parameter corresponding to the target task among the first parameters included in a neural network for a plurality of tasks. The neural network apparatus 700 may store information on the first parameters, for example, values of the first parameters, using the memory 750 or another memory.

Also, the processor 710 may perform one or more or any combination of the described above operations with reference to FIGS. 1 to 6B. The processor 710 may be a neural network device configured as hardware having a circuit in a physical structure to implement desired operations. In an example, the neural network apparatus may further store instructions, e.g., in memory 570, which when executed by the processor 710 configure the processor 710 to implement such one or more or any combination of operations. For example, the neural network device configured as hardware may include a microprocessor, a central processing unit, a processor core, a multi-core processor, a multiprocessor, an application-specific integrated circuit (ASIC), and a field programmable gate array (FPGA).

The memory 750 may store a variety of information generated during the processing process of the processor 710. In addition, the memory 750 may store various types of data and other programs executable by the neural network apparatus. The memory 750 may be a volatile memory or a non-volatile memory. The memory 750 may store a variety of data by including a large mass storage medium, such as a hard disc.

The neural network apparatuses, memory 230, processors, memory 405, memories 610, 630, 640, and 650, neural network apparatus 700, processor 710, communication interface 730, memory 750, and bus 705, and other apparatuses, units, modules, devices, and other components described herein and with respect to FIGS. 1-7 are, and are implemented, by hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods that perform the operations described in this application and illustrated in FIGS. 1-7 are performed by computing hardware, for example, by one or more processors or computers, implemented as described above executing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller, e.g., as respective operations of processor implemented methods. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computers using an interpreter. The instructions or software may be written using any programming language based on the block diagrams and the flow charts illustrated in the drawings and the corresponding descriptions in the specification, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A processor implemented neural network method, the method comprising:
determining a target task with respect to input data;
acquiring a second parameter that is prestored to correspond to the target task among first parameters included in a neural network for a plurality of tasks;
adapting the neural network to the target task by setting a value of a portion of the first parameters of the neural network to a value of the second parameter; and
implementing the adapted neural network with respect to the input data for the target task.

2. The method of claim 1, wherein the second parameter comprises at least one of a parameter corresponding to a key neuron for the target task, an index of the key neuron, a parameter corresponding to a key synapse for the target task, and an index of the key synapse.

3. The method of claim 1, wherein the second parameter comprises at least one of a parameter corresponding to a key filter for the target task and an index of the key filter.

4. The method of claim 1, further comprising:
receiving the input data; and
the determining of the target task includes estimating the target task based on the input data.

5. The method of claim 1, wherein the adapting of the neural network comprises:
initializing the neural network to include all of the first parameters; and
updating, to generate the adapted neural network, the initialized neural network based on the second parameter.

6. The method of claim 1, wherein the target task corresponds to one of the plurality of tasks.

7. The method of claim 1, further comprising:
obtaining an importance matrix with respect to the neural network for the plurality of tasks;
determining one or more key parameters of the neural network for the plurality of tasks;
updating the importance matrix with respect to the determined one or more key parameters; and
training the neural network for the plurality of tasks with training data and for a new task using the updated importance matrix.

8. A non-transitory computer readable storage medium storing instructions that, when executed by a processor, cause the processor to perform the method of claim 1.

9. A processor implemented neural network method, the method comprising:
training a neural network based on first training data for a first task, the trained neural network including a plurality of parameters;
extracting a second parameter from among the plurality of parameters based on determined importances of the plurality of parameters;
storing a value of the second parameter;
updating the importances, including updating an importance of the second parameter among the determined importances; and
retraining the neural network based on the updated importances and second training data for a second task.

10. The method of claim 9, wherein the updating of the importances comprises updating the importance of the second parameter by setting an element value of an importance matrix corresponding to the second parameter to a first logic value.

11. The method of claim 9, further comprising:
determining the imporances of the plurality of parameters by calculating the importances of the plurality of parameters.

12. The method of claim 11, wherein the calculating of the importances comprises calculating the importances of the plurality of parameters based on a set importance matrix.

13. The method of claim 9, wherein the second parameter comprises at least one of a parameter corresponding to a key neuron for the target task among a plurality of neurons included in the neural network, an index of the key neuron, a parameter corresponding to a key synapse for the target task among a plurality of synapses included in the neural network, and an index of the key synapse.

14. A non-transitory computer readable storage medium storing instructions that, when executed by a processor, cause the processor to perform the method of claim 9.

15. A neural network apparatus, the apparatus comprising:
a processor configured to:
determine a target task with respect to input data;
acquire a second parameter that is prestored in a memory to correspond to the target task among first parameters included in a neural network for a plurality of tasks;
adapt the neural network to the target task by setting a value of a portion of the first parameters of the neural network to a value of the second parameter; and
implement the adapted neural network with respect to the input data for the target task.

16. The apparatus of claim 15, further comprising:
a communication interface configured to receive the input data; and
the memory.

17. The apparatus of claim 15, wherein the second parameter comprises at least one of a parameter corresponding to a key neuron for the target task, an index of the key neuron, a parameter corresponding to a key synapse for the target task, and an index of the key synapse.

18. The apparatus of claim 15, wherein the second parameter comprises at least one of a parameter corresponding to a key filter for the target task and an index of the key filter.

19. The apparatus of claim 15, wherein, for the determination of the target task,
the processor is configured to estimate the target task based on the input data.

20. The apparatus of claim 15, wherein, for the adapting of the neural network, the processor is configured to initialize the neural network to include all of the first parameters, and update the initialized neural network based on the second parameter.

21. The apparatus of claim 15, wherein the target task corresponds to one of the plurality of tasks.

22. A neural network apparatus, the apparatus comprising:
a processor configured to:
train a neural network based on first training data for a first task, with the first trained neural network including a plurality of parameters;
extract a second parameter from among the plurality of parameters based on determined importances of the plurality of parameters;
store a value of the second parameter;
update the importances, including an update of an importance of the second parameter among the determined importances; and
retrain the neural network based on the updated importances and second training data for a second task; and
a memory configured to store the value of the second parameter.

23. The apparatus of claim 22, wherein the processor is configured to update the importance of the second parameter by setting an element value of an importance matrix corresponding to the second parameter to a first logic value.

24. The apparatus of claim 22, wherein the processor is configured to determine the importances of the plurality of parameters by calculating the importances of the plurality of parameters.

25. The apparatus of claim 24, wherein the processor is configured to calculate the importances of the plurality of parameters based on a set importance matrix.

26. The apparatus of claim 22, wherein the second parameter comprises at least one of a parameter corresponding to a key neuron for the target task among a plurality of neurons included in the neural network, an index of the key neuron, a parameter corresponding to a key synapse for the target task among a plurality of synapses included in the neural network, and an index of the key synapse.

27. A processor implemented neural network method, the method comprising:
obtaining first parameters of a neural network trained for a plurality of tasks, wherein the
obtained first parameters of the neural network are configured to implement less than the plurality of tasks;
acquiring one or more second parameters prestored to correspond to a target task among the plurality of tasks;
adapting the neural network trained for the plurality of tasks to include all of the first parameters except for one or more parameters of the first parameters that are respectively replaced by the one or more second parameters; and
implementing the adapted neural network with respect to input data for the target task.

28. The method of claim 27, further comprising:
obtaining an importance matrix with respect to the neural network trained for the plurality of tasks;
determining one or more key parameters of the neural network trained for the plurality of tasks;
updating the importance matrix with respect to the determined one or more key parameters; and
training the neural network trained for the plurality of tasks with training data and for a new task using the updated importance matrix.

29. The method of claim 27, wherein the updating of the importance matrix includes updating an importance value corresponding to each of the one or more determined key parameters to a first logic value.

30. The method of claim 29, further comprising:
generating the importance matrix by calculating importances of respective parameters of the neural network trained for the plurality of tasks.

31. The method of claim 27, wherein the one or more second parameters comprise at least one of a parameter corresponding to a key neuron for the target task, an index of the key neuron, a parameter corresponding to a key synapse for the target task, and an index of the key synapse.

32. The method of claim 27, wherein the one or more second parameters comprise at least one of parameter corresponding to a key filter for the target task and an index of the key filter.

33. A processor implemented neural network method, the method comprising:
obtaining first parameters of a trained neural network trained for a first task;
obtaining an importance matrix with respect to the neural network;
obtaining one or more key parameters of the neural network;
updating the importance matrix with respect to the determined one or more key parameters; and
retraining, using a loss dependent on the updated importance matrix, the neural network with training data to have a plurality of parameters configured to implement a second task.

34. The method of claim 33, further comprising:
acquiring one or more second parameters prestored to correspond to a target task;
adapting the retrained neural network to include all of the plurality of parameters except for one or more parameters of the plurality of parameters that are respectively replaced by the one or more second parameters; and
implementing the adapted neural network with respect to input data for the target task.

35. The method of claim 34, wherein the updating of the importance matrix includes updating an importance value corresponding to each of the one or more key parameters to a first logic value.

36. The method of claim 35, further comprising:
generating the importance matrix by calculating importances of respective parameters of the neural network trained for the first task.

37. The method of claim 33, wherein the one or more key parameters comprise at least one of a parameter corresponding to a key neuron for the target task, an index of the key neuron, a parameter corresponding to a key synapse for the target task, and an index of the key synapse.

38. The method of claim 33, wherein the one or more key parameters comprise at least one of parameter corresponding to a key filter for the target task and an index of the key filter.
